(19) United States
(12) Patent Application Publication
(10) Pub. No.: US 2012/0300115 A1
(43) Pub. Date: Nov. 29, 2012

(54) IMAGE SENSING DEVICE

(75) Inventor: Seiji OKADA, Hirakata City (JP)

(73) Assignee: SANYO ELECTRIC CO., LTD., Moriguchi City (JP)

(21) Appl. No.: 13/480,689

(22) Filed: May 25, 2012

(30) Foreign Application Priority Data
May 27, 2011 (JP) 2011-118719
Apr. 16, 2012 (JP) 2012-093143

(51) Int. Cl. H04N 5/232; G03B 13/20

(52) U.S. Cl. 348/348; 348/E05.045

(57) ABSTRACT

An image sensing device includes: a first image sensing portion that shoots a first image; a second image sensing portion that successively shoots a plurality of second images with focus positions different from each other; a distance information generation portion that generates, based on the second images, distance information on subjects on the first image; and an image processing portion that performs image processing using the distance information on the first image.

### CROSS-REFERENCE TO RELATED APPLICATIONS

This nonprovisional application claims priority under 35 U.S.C. §119(a) on Patent Application No. 2011-118719 filed in Japan on May 27, 2011 and Patent Application No. 2012-093143 filed in Japan on Apr. 16, 2012, the entire contents of which are hereby incorporated by reference.

### BACKGROUND OF THE INVENTION

1. Field of the Invention

The present invention relates to image sensing devices such as a digital still camera and a digital video camera.

2. Description of Related Art

A method of adjusting the focus state of a shooting image by image processing and thereby generating, after the shooting of an image, an image focused on an arbitrary subject is proposed, and one type of processing for realizing this method is also referred to as digital focus.

In the one type of image processing described above, distance information indicating the subject distance of each subject is utilized, and processing for blurring portions away from a main subject (subject to be focused) is performed based on the distance information. In general, in order for distance information to be generated based on an image, a plurality of images that are shot from different points of view are needed. When one image sensing portion (image sensing system) is provided in an image sensing device, a sub-image is separately shot with the point of view displaced before or after the shooting of a main image, and it is possible to generate distance information using the main image and the sub-image. However, this type of method is likely to place a greater burden (such as time constraint) on a user. By contrast, when two image sensing portions (image sensing systems) are provided in an image sensing device, it is possible to generate distance information using the principle of triangulation based on two shooting images by the two image sensing portions.

However, in the processing for generating the distance information using the principle of triangulation based on two shooting images by the two image sensing portions, a necessary amount of calculation is correspondingly increased, and a necessary waiting time for obtaining the distance information is correspondingly increased. If an image (for example, an image focused on an arbitrary subject) after the adjustment of a focus state can be generated with a small amount of waiting time, it is naturally useful. This holds true not only for image processing for adjusting a focus state but also for an arbitrary image sensing device that performs image processing using distance information.

### SUMMARY OF THE INVENTION

An image sensing device according to the present invention includes: a first image sensing portion that shoots a first image; a second image sensing portion that successively shoots a plurality of second images with focus positions different from each other; a distance information generation portion that generates, based on the second images, distance information on subjects on the first image; and an image processing portion that performs image processing using the distance information on the first image.

### BRIEF DESCRIPTION OF THE DRAWINGS

FIG. 1 is a schematic overall block diagram of an image sensing device according to a first embodiment of the present invention;

FIG. 2 is a diagram showing the internal configuration of one image sensing portion shown in FIG. 1;

FIG. 3 is a diagram showing how a target result image is obtained from one sheet of main image and n sheets of sub-images in the first embodiment of the present invention;

FIG. 4 is a flow chart of an operation of generating the target result image from the one sheet of main image and the n sheets of sub-image;

FIG. 5 is a diagram showing a distance relationship between the image sensing device and each of subjects;

FIG. 6 is a diagram showing how a main subject region is set on the main image;

FIG. 7 is an internal block diagram of a high-frequency evaluation portion;

FIG. 8 is a diagram showing how the entire image region of each of the sub-images is divided into a plurality of small blocks;

FIG. 9 is a block diagram of portions that are particularly involved in the operation of obtaining the target result image in a second embodiment of the present invention;

FIG. 10 is a diagram showing how two sheets of target result images are obtained from a left eye image and a right eye image in the second embodiment of the present invention; and

FIG. 11 is a flow chart of an operation of generating the target result images in the second embodiment of the present invention.

### DETAILED DESCRIPTION OF PREFERRED EMBODIMENTS

Examples of embodiments of the present invention will be specifically described below with reference to accompanying drawings. In the referenced drawings, like parts are identified with like symbols, and the description of the like parts will not be repeated in principle. In the present specification, for ease of description, a sign or a symbol representing information, a physical amount, a state amount, a member or the like is shown, and thus the name of the information, the physical amount, the state amount, the member or the like corresponding to the sign or the symbol may be omitted or described for short.

### First Embodiment

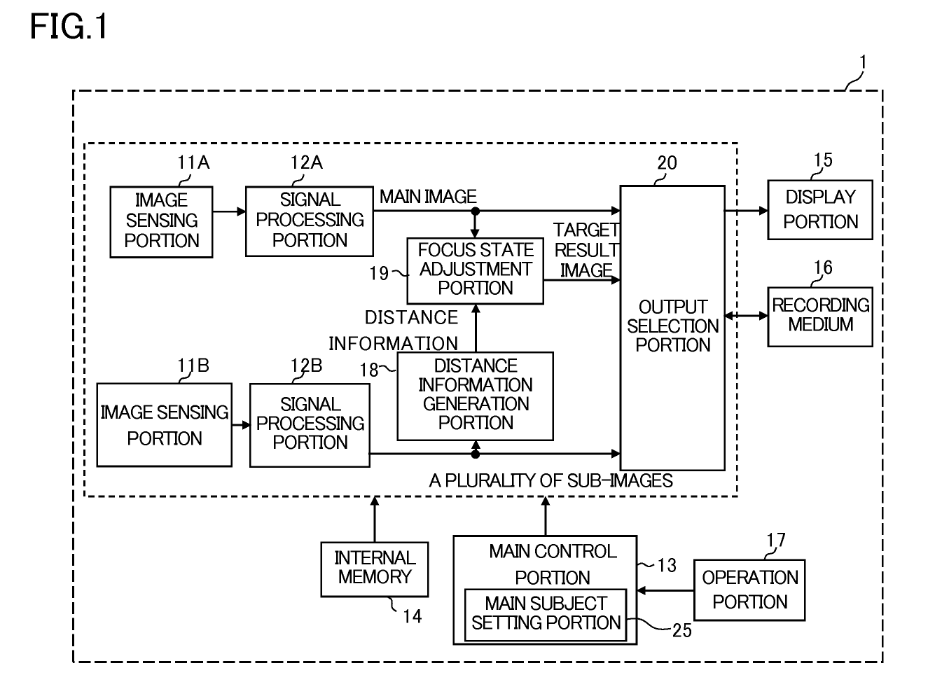

A first embodiment of the present invention will be described. FIG. 1 is a schematic overall block diagram of an image sensing device 1 according to the first embodiment of the present invention. The image sensing device 1 is a digital video camera that can shoot and record a still image and a moving image. The image sensing device 1 may be a digital still camera that can shoot and record only a still image. The image sensing device 1 may be incorporated in a mobile terminal such as a mobile telephone.

The image sensing device 1 includes a first processing unit composed of an image sensing portion 11A and a signal processing portion 12A and a second processing unit composed of an image sensing portion 11B and a signal processing portion 12B, and further includes portions represented by symbols 13 to 20. The first processing unit and the second processing unit can have the same function as each other.

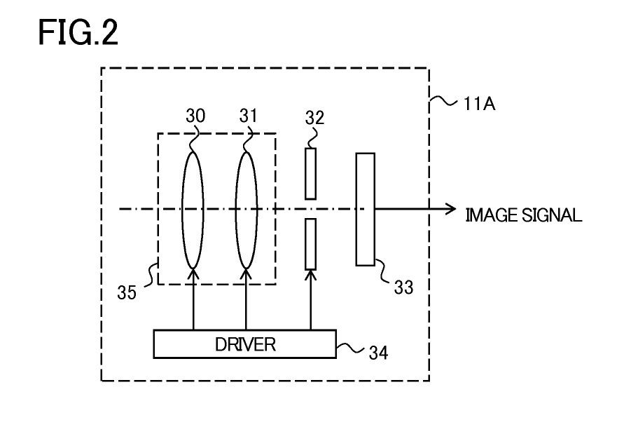

FIG. 2 is a diagram showing the internal configuration of the image sensing portion 11A. The image sensing portion 11A includes: an optical system 35 that is formed with a plurality of lenses including a zoom lens 30 and a focus lens 31; an aperture 32; an image sensor (solid-state image senor) 33 that is formed with a CCD (charge coupled device), a CMOS (complementary metal oxide semiconductor) image sensor or the like; and a driver 34 that drives and controls the optical system 35 and the aperture 32. The image sensor 33 photoelectrically converts an optical image of a subject within a shooting region that enters the image sensor 33 through the optical system 35 and the aperture 32, and outputs an electrical signal (image signal) obtained by the photoelectrical conversion. The shooting region refers to the shooting region (sight view) of the image sensing device 1. The positions of the lenses 30 and 31 and the degree of opening of the aperture 32 are controlled by a main control portion 13. The internal configuration and the function of the image sensing portion 11B are the same as those of the image sensing portion 11A. When the image sensing portion 11A utilizes only deep focus, which will be described later, the position of the focus lens 31 of the image sensing portion 11A may be fixed.

The signal processing portion 12A performs predetermined signal processing (such as digitalizing, signal amplification, noise reduction processing and demosaicking processing) on the output signal of the image sensor 33 of the image sensing portion 11A, and outputs an image signal on which the signal processing has been performed. The signal processing portion 12B performs predetermined signal processing (such as digitalizing, signal amplification, noise reduction processing and demosaicking processing) on the output signal of the image sensor 33 of the image sensing portion 11B, and outputs an image signal on which the signal processing has been performed. In the present specification, a signal indicating an arbitrary image is referred to as an image signal. The output signal of the image sensor 33 is also one type of image signal. In the present specification, an image signal (image data) of a certain image is also simply referred to as an image. The output signal of the image sensor 33 of the image sensing portion 11A or 11B is also referred to as an output signal (output image signal) of the image sensing portion 11A or 11B.

The main control portion 13 comprehensively controls the operations of the individual portions of the image sensing device 1. An internal memory 14 is formed with a SDRAM (synchronous dynamic random access memory) or the like, and temporarily stores various signals (data) generated within the image sensing device 1. A display portion 15 is formed with a liquid crystal display panel or the like, and displays, under the control of the main control portion 13, a shooting image or an image or the like recorded in a recording medium 16. The recording medium 16 is a nonvolatile memory such as a card-shaped semiconductor memory or a magnetic disc, and records a shooting image or the like under the control of the main control portion 13. The shooting image refers to an image in a shooting region based on the output signal of the image sensor 33 of the image sensing portion 11A or 11B. An operation portion 17 receives various types of operations from a user. The details of the operation of the user on the operation portion 17 are transmitted to the main control portion 13; under the control of the main control portion 13, each portion of the image sensing device 1 performs an operation corresponding to the details of the operation. The operation portion 17 may include a touch panel.

An image based on an image signal from the signal processing portion 12A or an image based on an image signal from the signal processing portion 12B is output to the display portion 15 through an output selection portion 20 under the control of the main control portion 13, and thus the image can be displayed on the display portion 15; alternatively, the image based on an image signal from the signal processing portion 12A or an image based on an image signal from the signal processing portion 12B is output to the recording medium 16 through the output selection portion 20 under the control of the main control portion 13, and thus the image can be recorded in the recording medium 16.

The image sensing device 1 may have the function of generating distance information on the subject using the output signal of the image sensing portions 11A and 11B based on the principle of triangulation and have the function of restoring three-dimensional information on the subject using the shooting images by the image sensing portions 11A and 11B. A characteristic operation α using the image sensing portion 11A as a main image sensing portion and the image sensing portion 11B as a sub-image sensing portion will be described below.

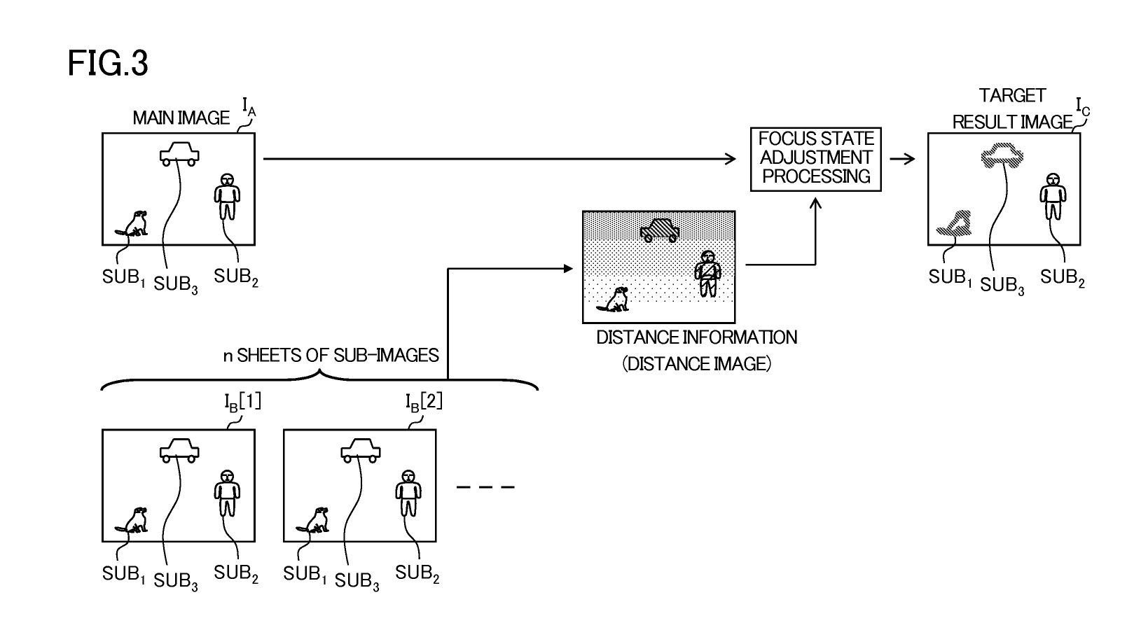

A conceptual diagram of the characteristic operation α is shown in FIG. 3. In the characteristic operation α, the image sensing portion 11A shoots one sheet of main image I_{A}, and the image sensing portion 11B successively shoots a plurality of sub-images I_{B}. Here, while the position of the focus lens 31 of the image sensing portion 11B is being displaced by a predetermined amount, a plurality of sub-images I_{B} are successively shot, and thus the focus state of the sub-image I_{B} is made to differ between the sub-images I _{B}. The sub-images I_{B} are represented by symbols I_{B}[1], I_{B}[2], . . . and I_{B}[n]. Here, n is an integer of two or more. When p and q are different integers, the focus position of the image sensing portion 11B differs between when a sub-image I_{B}[p] is shot and when a sub-image I_{B}[q] is shot. In other words, the sub-images I_{B}[1] to I_{B}[n] are successively shot with the focus position of the image sensing portion 11B different from each other. When a plurality of lenses within the optical system 35 of the image sensing portion 11B are regarded as a single image sensing lens, the focus position of the image sensing portion 11B may be interpreted as the position of the focus of the image sensing lens.

The main image I_{A} and the sub-images I_{B}[1] to I_{B}[n] are shooting images of common subjects; the subjects included in the main image I_{A} are included in each of the sub-images I_{B}[1] to I_{B}[n]. For example, the angle of view of each of the sub-images I_{B}[1] to I_{B}[n] is substantially the same as that of the main image I_{A}. The angle of view of each of the sub-images I_{B}[1] to I_{B}[n] may be larger than that of the main image I_{A}.

In the present embodiment, it is assumed that, in the shooting region of the image sensing portions 11A and 11B when the main image I_{A} and the sub-images I_{B}[1] to I_{B}[n] are shot, a subject SUB₁ which is a dog, a subject SUB₂ who is a person and a subject SUB₃ which is a car are present.

A distance information generation portion 18 of FIG. 1 generates, based on the image signals of the sub-images I_{B}[1] to I_{B}[n], distance information indicating the subject distances of the subjects on the main image I_{A}. The subject distance of a certain subject refers to the distance of an actual space between the subject and the image sensing device 1. The distance information can be said to be a distance image in which each pixel value forming itself has a detection value of the subject distance. The distance information specifies both the subject distance of the subject in an arbitrary pixel position of the main image I_{A} and the subject distance of the subject in an arbitrary pixel position of the sub-image I_{B} [i] (i is an integer). In the distance information (distance image) shown in FIG. 3, as a portion has a longer subject distance, the portion is more darkened.

A focus state adjustment portion 19 of FIG. 1 performs focus state adjustment processing on the main image I_{A} based on the distance information, and outputs, as a target result image I_{C}, the main image I_{A} after the focus state adjustment processing. The focus state adjustment processing includes blurring processing for blurring part of the main image I_{A} (the details of which will be described later).

In the characteristic operation α, the image sensing portion 11A can perform shooting with so-called deep focus (in other words, pan focus), and thus the shooting image of the image sensing portion 11A including the main image I_{A} can become an ideal or pseudo entire focus image. The entire focus image refers to an image that is focused on all subjects in which image signals are present on the entire focus image. The shooting image (including the main image I_{A}) of the image sensing portion 11A obtained by using deep focus has a sufficiently deep depth of field; the depth of field of the shooting image (including the main image I_{A}) of the image sensing portion 11A is deeper than that of each of the sub-images I_{B}[1] to I_{B}[n]. Here, for ease of description, all subjects placed in the shooting region of the image sensing portion 11A and 11B are assumed to be placed within the depth of field of the shooting image (including the main image I_{A}) of the image sensing portion 11A.

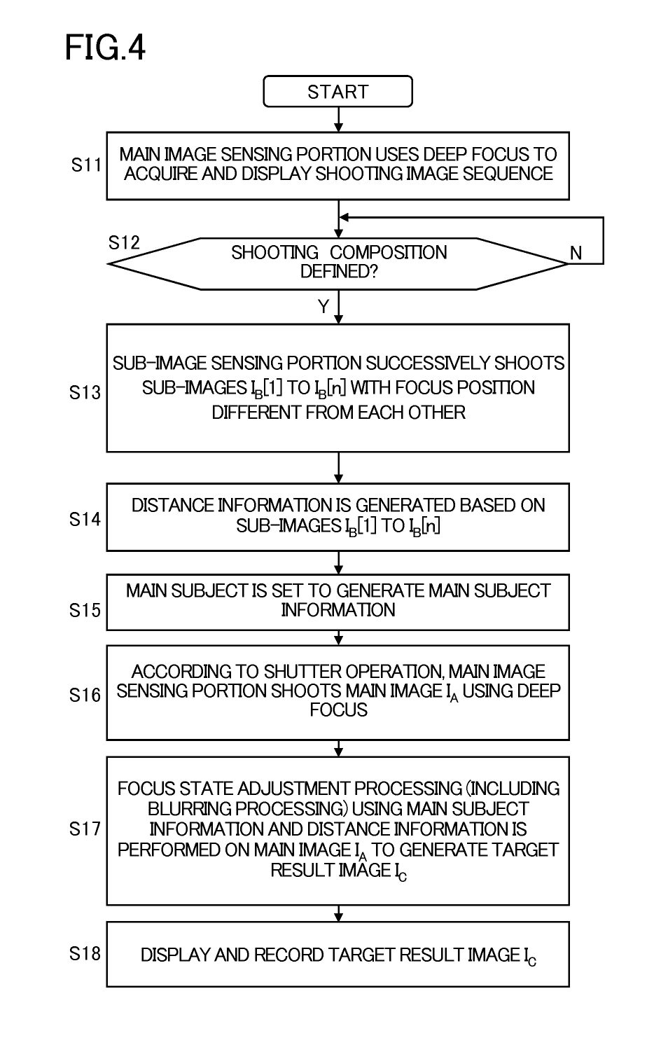

FIG. 4 is a flow chart showing the operational procedure of the characteristic operation α. The procedure of the characteristic operation α will be described with respect to FIG. 4.

In step S11, the image sensing portion 11A, which is the main image sensing portion, first acquires a shooting image sequence in deep focus. The obtained shooting image sequence is displayed as a moving image on the display portion 15. The shooting image sequence refers to a collection of shooting images that are aligned chronologically. For example, in step S11, the image sensing portion 11A sequentially acquires shooting images using deep focus at a predetermined frame rate, and thus a shooting image sequence to be displayed on the display portion 15 is acquired. The user checks the details of the display on the display portion 15, and thereby can check the angle of view of the image sensing portion 11A and the state of the subjects. The acquisition and the display of the shooting image sequence in step S11 are continued at least until a shutter operation, which will be described later, is performed.

While the acquisition and the display of the shooting image sequence in step S11 are being performed, in step S12, the main control portion 13 (a composition defining determination portion included in the main control portion 13) determines whether or not a shooting composition is defined. Only if the shooting composition is determined to be defined, the process moves from step S12 to step S13.

For example, a movement sensor (not shown) that detects the angular acceleration or the acceleration of the enclosure of the image sensing device 1 can be provided in the image sensing device 1. In this case, the main control portion 13 uses the results of the detection by the movement sensor and thereby can monitor the movement of the image sensing device 1. Alternatively, the main control portion 13 derives an optical flow from the output signal of the image sensing portion 11A or 11B, and thereby can monitor the movement of the image sensing device 1 based on the optical flow. Then, if, based on the results of the monitoring of the movement of the image sensing device 1, the image sensing device 1 is determined to be stopped, the main control portion 13 can determine that the shooting composition is defined.

When the user performs a predetermined zoom operation on the operation portion 17, under the control of the main control portion 13, in the image sensing portions 11A and 11B, the zoom lens 30 is moved within the optical system 35, and thus the angle of view (that is, an optical zoom magnification) of the image sensing portions 11A and 11B is changed. When, after the angle of view of the image sensing portions 11A and 11B is changed according to the zoom operation, no further zoom operation has been performed for a predetermined continuous period of time (that is, when the angle of view of the image sensing portions 11A and 11B has been fixed), the main control portion 13 may determine that the shooting composition is defined. Alternatively, when a predetermined angle-of-view defining operation (for example, an operation of pressing a special button) is performed on the operation portion 17, the main control portion 13 may determine that the shooting composition is defined. A first determination as to whether or not the image sensing device 1 stands still and a second determination (or a second determination as to whether or not the predetermined angle-of-view defining operation is performed on the operation portion 17) as to whether or not the angle of view of the image sensing portions 11A and 11B is fixed are combined and used, with the result that the main control portion 13 may determine whether or not the shooting composition is defined.

In step S13, the main control portion 13 controls the image sensing portion 11B such that the image sensing portion 11B, which is the sub-image sensing portion, successively shoots the sub-images I_{B}[1] to I_{B}[n]. As described above, while the image sensing portion 11B is displacing the position of the focus lens 31 by the predetermined amount, the image sensing portion 11B successively shoots the sub-images I_{B}[1] to I_{B}[n], with the result that the focus position of the sub-image I_{B} (that is, the focus state of the sub-image I_{B}) is made to differ between a plurality of sub-images I_{B}. In order to complete the shooting of the sub-images I_{B}[1] to I_{B}[n] for a short period of time, it is preferable to shoot the sub-images I_{B}[1] to I_{B}[n] at a relatively high frame rate (for example, 300 fps (frame per second)).

Thereafter, in step S14, the distance information generation portion 18 generates the distance information based on the sub-images I_{B}[1] to I_{B}[n] (an example of the method of generating the distance information will be described later).

On the other hand, in step S15, a main subject setting portion 25 (see FIG. 1) within the main control portion 13 sets the main subject and generates main subject information including the results of the setting. In step S15, any of the subjects present in the main image I_{A} is set at the main subject.

The main subject setting portion 25 can set the main subject, regardless of the user operation, based on the output image signal of the image sensing portion 11A or 11B indicating the results of the shooting by the image sensing portion 11A or 11B. For example, based on the output image signal of the image sensing portion 11A, the main subject setting portion 25 detects a specific type of object present on the shooting image of the image sensing portion 11A, and can set the detected specific type of object at the main subject (the same is true when the output image signal of the image sensing portion 11B is used). The specific type of object is, for example, an arbitrary person, a previously registered specific person, an arbitrary animal or a moving object. The moving object present on the shooting image of the image sensing portion 11A refers to an object that moves on the shooting image sequence of the image sensing portion 11A. When the main subject is set based on the output image signal of the image sensing portion 11A or 11B, it is possible to further utilize information on the composition. For example, by utilizing knowledge that the main subject is more likely to be present either in the center portion of or around the center of the shooting image, the main subject may be set. A frame surrounding the set main subject is preferably superimposed and displayed on the shooting image displayed on the display portion 15.

The user, who is a photographer, can perform, on the operation portion 17, a main subject specification operation for specifying the main subject; when the main subject specification operation is performed, the main subject setting portion 25 may set the main subject according to the main subject specification operation. For example, a touch panel (not shown) is provided in the operation portion 17, and, with the shooting image of the image sensing portion 11A displayed on the display portion 15, the operation portion 17 receives the main subject specification operation for specifying any of the subjects on the shooting image displayed on the display portion 15 through a touch panel operation (an operation of touching the touch panel). In this case, the subject specified by the touch panel operation is preferably set at the main subject.

The main subject setting portion 25 may set a plurality of candidates of the main subject based on the output image signal of the image sensing portion 11A or 11B and display the candidates on the display portion 15. In this case, the user performs, on the operation portion 17, the touch panel operation of or an operation (such as the button operation), other than the touch panel operation, of selecting the main subject from the candidates, and thus it is possible to set the main subject.

The main subject information generated in step S15 of FIG. 4 specifies an image region (hereinafter referred to as a main subject region) where the image signal of the main subject is present on the shooting image (including the main image I_{A}) of the image sensing portion 11A.

After the shooting composition is defined in step S12, the user performs a predetermined shutter operation on the operation portion 17. When the shutter operation is performed, in step S16, the image sensing portion 11A shoots the main image I_{A} using deep focus. Preferably, either successive shooting processing in step S13 and distance information generation processing in step S14 or at least the successive shooting processing in step S13 is completed before the completion of the shooting of the main image I_{A}. In order for this to be achieved, a frame rate of the image sensing portion 11 B at the time of the shooting of the sub-images I_{B}[1] to I_{B}[n] is preferably set higher than a frame rate of the image sensing portion 11A. The distance information generation processing in step S14 can be performed simultaneously with the shooting operation of the main image I_{A}. In the example of the operational procedure of FIG. 4, the shooting processing in step S16 is performed after the processing in steps S13 and S14. As is well known, the frame rate of the image sensing portion 11A represents the number of images (frames) that are shot by the image sensing portion 11A per unit time. The same is true for the frame rate of the image sensing portion 11B. Although, in FIG. 4, the processing in step S15 is performed after the processing in steps S13 and S14 and before the processing in step S16, the processing for the main subject setting in step S15 may be performed at an arbitrary timing after the shooting composition is determined to be defined until the processing in step S17, will be described later, is performed.

After the shooting of the main image I_{A}, in step S17, the focus state adjustment portion 19 performs, on the main image I_{A}, the focus state adjustment processing using the main subject information and the distance information, and outputs, as the target result image I_{C}, the main image I_{A} after the focus state adjustment processing. Then, in step S18, the image signal of the target result image I_{C} is output through the output selection portion 20 to the display portion 15 and the recording medium 16, and thus the target result image I_{C} is displayed on the display portion 15 and is recorded in the recording medium 16. The main image I_{A} or the sub-images I_{B}[1] to I_{B}[n] can also be recorded in the recording medium 16 together with the target result image I_{C}. Alternatively, the main image I_{A} and the distance information (distance image) can be recorded in the recording medium 16.

The focus state adjustment processing includes blurring processing that blurs a subject having a subject distance that is different from the subject distance of the main subject. The focus state adjustment processing may further include edge enhancement processing or the like that enhances the edges of an image within the main subject region.

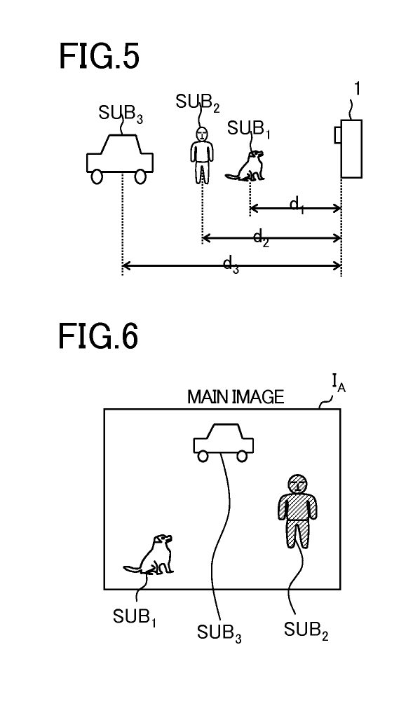

The details of the blurring processing will be described with reference to FIGS. 5 and 6. As shown in FIG. 5, the subject distances of subjects SUB₁, SUB₂ and SUB₃ are represented by symbols d₁, d₂ and d₃, respectively, and an inequality “0<d₁<d₂<d₃” is assumed to hold true. It is also assumed that, among the subjects SUB₁, SUB₂ and SUB₃, the subject SUB₂ is set at the main subject. In this case, an image region where the image signal of the subject SUB₂ is present, which corresponds to the shaded area of FIG. 6, is set at the main image I_{A} as the main subject region.

In the blurring processing, the focus state adjustment portion 19 blurs a subject (hereinafter referred to as a non-main subject) having a subject distance that is different from the subject distance d₂ of the main subject SUB₂. More specifically, a subject having a subject distance that is equal to or less than a distance (d₂−Δd_{A}) and a subject having a subject distance that is equal to or more than a distance (d₂+Δd_{B}) are non-main subjects. The distances Δd_{A} and Δd_{B} are positive distance values that are defined according to the magnitude (depth) of the depth of field of the target result image I_{C}. The user can also specify the magnitude (depth) of the depth of field of the target result image I_{C} through the operation on the operation portion 17.

Here, it is assumed that all subjects (including the subjects SUB₁ and SUB₃ and the background) other than the subject SUB₂ are non-main subjects. Then, the image region other than the main subject region within the entire image region of the main image I_{A} is set at the blurring target region, and images within the blurring target region are blurred by the blurring processing. The blurring processing may be low-pass filter processing that lowers a relatively high spatial frequency component of the spatial frequency components of the images within the blurring target region. The blurring processing can be realized by spatial domain filtering or frequency domain filtering.

When, in the blurring processing, the focus state adjustment portion 19 blurs the non-main subject SUB₁ based on the distance information, as the difference distance d₁₂ between the subject distance d₁ of the non-main subject SUB₁ and the subject distance d₂ of the main subject SUB₂ is increased, the focus state adjustment portion 19 increases a blurring intensity on the non-main subject SUB₁ (d₁₂=|d₁−d₂|). The same is true for the non-main subjects other than the non-main subject SUB₁. As the blurring intensity on the non-main subject SUB₁ is increased, in the target result image I_{C}, the image of the non-main subject SUB₁ is more blurred. For example, when the blurring processing is realized in spatial domain filtering using a Gaussian filter, the filter size of the Gaussian filter is increased as the difference distance d₁₂ is increased, and thus it is possible to increase the blurring intensity on the non-main subject SUB₁.

The target result image I_{C} shown in FIG. 3 is an example of the target result image I_{C} obtained under the assumption described above. In FIG. 3, the blurring of the image is represented by the thickness of the outline of the subject.

A subject SUB₄ (not shown) having a subject distance that is equal to the subject distance d₂ of the main subject SUB₂ can be included in the non-main subjects although it is different from the above description. Here, the subject SUB₄ is a subject, other than the subjects SUB₁ to SUB₃, that appears on the main image I_{A} and the sub-images I_{B}[1] to I_{B}[n] together with the subjects SUB₁ to SUB₃. For example, as with the method described above, the main subject setting portion 25 can set only the subject SUB₂ among the subjects SUB₁ to SUB₄ at the main subject, and can set all subjects (including the subjects SUB₁, SUB₃ and SUB₄) other than the main subject SUB₂ at the non-main subjects. In this case, not only the image region where the image signals of the subjects SUB₁ and SUB₃ are present but also the image region where the image signal of the subject SUB₄ is present is included in the blurring target region and is blurred by the blurring processing.

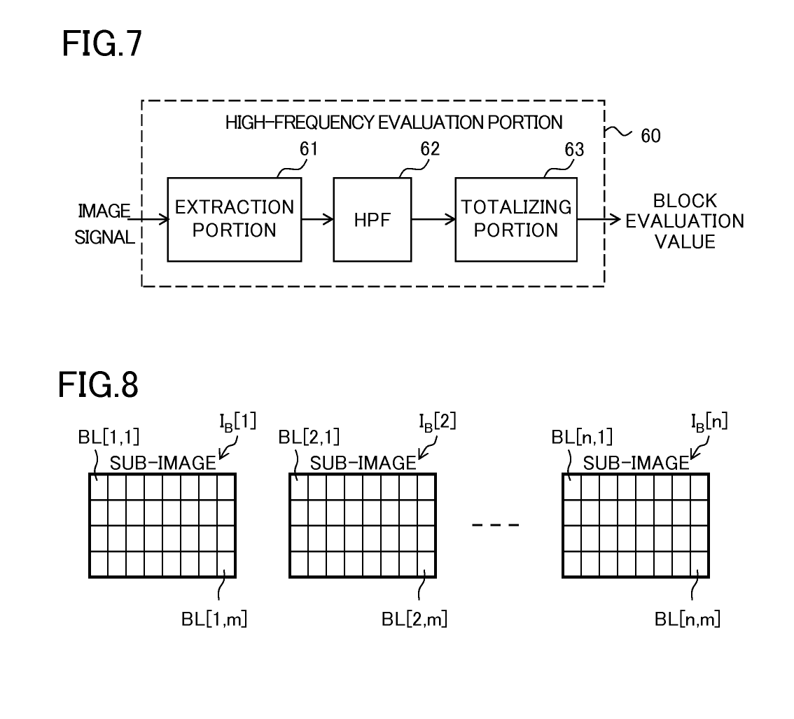

An example of the method of generating the distance information based on the sub-images I_{B}[1] to I_{B}[n] will now be described. Reference is given to FIGS. 7 and 8. FIG. 7 is an internal block diagram of a high-frequency evaluation portion 60 that is utilized for the generation of the distance information. The high-frequency evaluation portion 60 can be provided in the distance information generation portion 18.

As shown in FIG. 8, the high-frequency evaluation portion 60 divides the entire image region of each of the sub-images I_{B}[1] to I_{B}[n] into m pieces, and thereby sets m small blocks in each of the sub-images I_{B}[1] to I_{B}[n] (m is an integer of two or more). In the sub-image I_{B}[i], the j-th small block is represented by a symbol BL[i, j] (i and j are integers, and inequalities 1≦i≦n and 1≦j≦m hold true). In each of the sub-images, the m small blocks are equal in size to each other. The position of a small block BL[1, j] on the sub-image I_{B}[1], the position of a small block BL[2, j] on the sub-image I_{B}[2], . . . and the position of a small block BL[n, j] on the sub-image I_{B}[n] are the same as each other, and consequently, the small blocks BL[1, j], BL[2, j], . . . and BL[n, j] correspond to each other.

As shown in FIG. 7, the high-frequency evaluation portion 60 includes an extraction portion 61, a HPF (high-pass filter) 62 and a totalizing portion 63. The high-frequency evaluation portion 60 calculates a block evaluation value (high-frequency component value) for each of the small blocks in each of the sub-images. Hence, m block evaluation values are calculated for one sheet of sub-image.

The image signals of the sub-image are input into the extraction portion 61. The extraction portion 61 extracts a luminance signal from the input image signals. The HPF 62 extracts a high-frequency component from the luminance signal extracted by the extraction portion 61. The high-frequency component extracted by the HPF 62 is a specific spatial frequency component having a relatively high frequency; the specific spatial frequency component can also be said to be a spatial frequency component having a frequency within a predetermined range; it can also be said to be a spatial frequency component having a frequency equal to or higher than a predetermined frequency. For example, the HPF 62 is formed with a Laplacian filter having a predetermined filter size, and spatial domain filtering that acts on each pixel of the sub-image by the Laplacian filter is performed. In this way, output values corresponding to the filter characteristic of the Laplacian filter are sequentially acquired from the HPF 62. The totalizing portion 63 totalizes the magnitude (that is, the absolute value of the output value of the HPF 62) of the high-frequency component extracted by the HPF 62. The totalizing is performed on each of the small blocks of one sheet of sub-image; a totalized value of the magnitude of the high-frequency component within a certain small block is regarded as the block evaluation value of such a small block. Computation processing for determining the block evaluation value for each small block is performed on each sub-image, and thus m block evaluation values are determined for each sub-image.

The distance information generation portion 18 compares the block evaluation values of small blocks corresponding to each other between the sub-images I_{B}[1] to I_{B}[n], and thereby generates the distance information.

The distance information to be generated is formed as the distance information on each small block. The method of generating the distance information corresponding to the first small block BL[i, 1] will be described. The distance information generation portion 18 specifies the maximum value among n block evaluation values VAL[1, 1] to VAL[n, 1] determined for the small blocks BL[1, 1] to BL[n, 1], and specifies a sub-image corresponding to the maximum value as a focus sub-image. For example, if, among the block evaluation values VAL[1, 1] to VAL[n, 1], the block evaluation value VAL[2, 1] is the maxim value, the sub-image I_{B}[2] corresponding to the block evaluation value VAL[2, 1] is specified as the focus sub-image. In this case, based on the position of the focus lens 31 within the image sensing portion 11B at the time of the shooting of the sub-image I_{B}[2], the distance information corresponding to the first small block BL[i, 1] is determined. The distance information corresponding to another small block is determined in the same manner.

As in the same manner as the sub-image, m small blocks can be set in each main image I_{A}, and the distance information corresponding to the j-th small block BL[i, j] functions as the distance information on the j-th small block of the main image I_{A}. The subject within the j-th small block BL[i, j] of the sub-image I_{B}[i] and the subject within the j-th small block of the main image I_{A} are the same as each other. The distance information corresponding to the small block BL[i, j] indicates the subject distance of each subject within the j-th small block of the main image I_{A}.

Another method is to use, in an image sensing device including two image sensing portions, the principle of triangulation based on first and second images shot simultaneously with the two image sensing portions and thereby generate the distance information, and thereafter use the distance information and thereby perform the focus state adjustment processing on the first image. However, in this method, it is impossible to perform the focus state adjustment processing after the shooting of the first image until the processing for calculating the distance information is completed, and thus the waiting time for acquisition of the target result image is increased. By contrast, since, in the present embodiment, the generation of the distance information has been completed at the time of completion of the shooting of the main image, the focus state adjustment processing can be performed immediately after the completion of the shooting of the main image, with the result that the waiting time for acquisition of the target result image is reduced.

### Second Embodiment

The second embodiment of the present invention will be described. The second embodiment is an embodiment based on the first embodiment; what has been described in the first embodiment can be applied to the second embodiment unless a contradiction arises. In the second embodiment, other image processing that can be performed with the image sensing device 1 will be described.

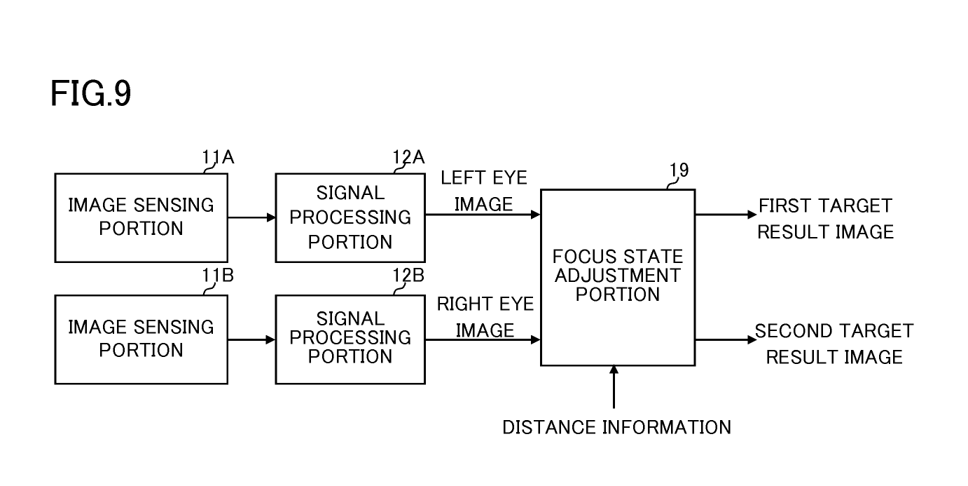

FIG. 9 is a block diagram of portions that are particularly involved in the image processing operation of the second embodiment. The focus state adjustment portion 19 of FIG. 9 is the same as in FIG. 1.

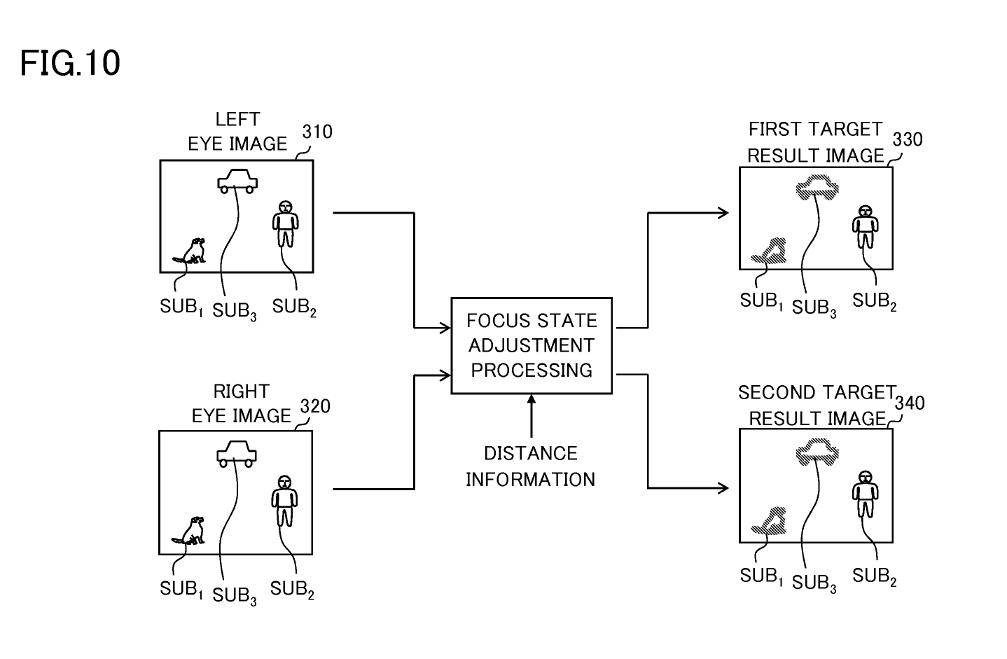

The image sensing portions 11A and 11B form a stereo camera having parallax. Shooting images by the image sensing portions 11A and 11B, which are constituent elements of the stereo camera, are referred to as a left eye image and a right eye image, respectively. The left eye image and the right eye image are shooting images of the common subject. In FIG. 10, images 310 and 320 are examples of the left eye image and the right eye image. In each of the images 310 and 320, there are subjects SUB₁ to SUB₃ as common subjects. The left eye image 310 is a shooting image of subjects (including the subjects SUB₁ to SUB₃) when seen from the point of view of the image sensing portion 11A; the right eye image 320 is a shooting image of subjects (including the subjects SUB₁ to SUB₃) when seen from the point of view of the image sensing portion 11B. The points of view of the image sensing portions 11A and 11B are different from each other. The images 310 and 320 generally have the common angle of view; the angle of view of one of the images 310 and 320 may be included in the angle of view of the other image.

The focus state adjustment portion 19 according to the second embodiment performs, on each of the left eye image 310 and the right eye image 320, the focus state adjustment processing based on the distance information, and thereby generates first and second target result images 330 and 340. The target result image 330 is the left eye image 310 on which the focus state adjustment processing has been performed; the target result image 340 is the right eye image 320 on which the focus state adjustment processing has been performed. The distance information utilized in the focus state adjustment portion 19 of FIG. 9 is generated by the distance information generation portion 18 (see FIG. 1) according to the method described in the first embodiment. The focus state adjustment processing on each of the left eye image 310 and the right eye image 320 is the same as the focus state adjustment processing on the main image I_{A} described in the first embodiment. Hence, the focus state adjustment processing on the left eye image 310 includes the blurring processing for blurring the non-main subjects on the left eye image 310; the focus state adjustment processing on the right eye image 320 includes the blurring processing for blurring the non-main subjects on the right eye image 320. The method of setting the main subject is the same as described in the first embodiment.

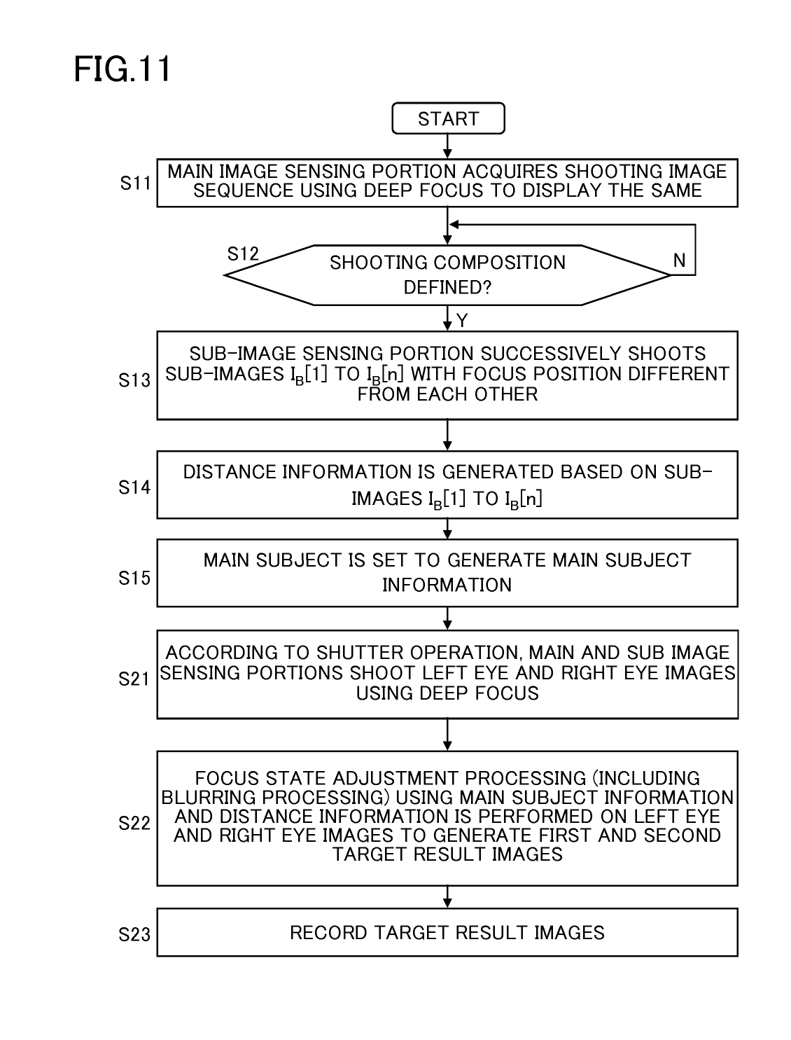

FIG. 11 is an operational flow chart of the image sensing device 1 according to the second embodiment. Even in the operation of the image sensing device 1 according to the second embodiment, the processing steps in steps S11 to S15 described in the first embodiment (see FIG. 4) are sequentially performed. In the second embodiment, after the processing in steps S11 to S15, processing in steps S21 to S23 is performed in response to the shutter operation. Timings at which the processing for generating the distance information in step S14 and the processing for generating the main subject information in step S15 are performed may be arbitrary timings before the focus state adjustment processing in step S22 is performed.

After the shooting composition is defined, the user performs the predetermined shutter operation on the operation portion 17. After the shutter operation is performed, in step S21, the image sensing portion 11A serving as the main image sensing portion shoots the left eye image 310 using deep focus, and simultaneously, the image sensing portion 11B serving as the sub-image sensing portion shoots the right eye image 320 using deep focus. Although the expressions “main” and “sub” are used in association with the description of the first embodiment, there is no master-servant relationship between the image sensing portions 11A and 11B when the images 310 and 320 are shot. Each of the left eye image 310 and the right eye image 320 shot using deep focus (in other words, pan focus) is an ideal or pseudo entire focus image having a sufficiently deep depth of field, as with the main image I_{A} of the first embodiment. The left eye image 310 may be the same as the main image I_{A}. Here, it is assumed that all the subjects placed in the shooting region of the image sensing portions 11A and 11B are placed in the depth of field of each of the left eye image 310 and the right eye image 320.

After the shooting of the images 310 and 320, in step S22, the focus state adjustment portion 19 performs the focus state adjustment processing using the main subject information and the distance information on each of the left eye image 310 and the right eye image 320, and thereby generates the first and second target result images 330 and 340. Thereafter, in step S23, the image signals of the target result images 330 and 340 are output through the output selection portion 20 (see FIG. 1) to the recording medium 16, and thus the target result images 330 and 340 are recorded in the recording medium 16. Here, the image sensing device 1 can also record, together with the target result images 330 and 340, the images 310 and 320 in the recording medium 16. The image sensing device 1 can also either record the images 310 and 320 and the distance information in the recording medium 16 or record the left eye image 310 which is the main image I_{A}, the sub-images I_{B}[1] to I_{B}[n] and the right eye image 320 in the recording medium 16.

Each of the target result images 330 and 340 is a two-dimensional image having a depth of field shallower than those of the images 310 and 320. When the image signals of the target result images 330 and 340 are supplied to a display device for three-dimensional images, the display device displays the target result images 330 and 340 such that the viewer of the display device can see the target result image 330 only with the left eye and the target result image 340 only with the right eye. In this way, the viewer can recognize the three-dimensional image of the subject that has a depth of field corresponding to the focus state adjustment processing. The display device described above may be the display portion 15.

### Variations and the Like

In the embodiments of the present invention, many modifications are possible as appropriate within the scope of the technical spirit shown in the scope of claims. The embodiments described above are simply examples of the embodiment of the present invention; the present invention or the significance of terms of constituent requirements is not limited to what has been described in the embodiments discussed above. The specific values indicated in the above description are simply illustrative; naturally, they can be changed to various values. Explanatory notes 1 and 2 will be described below as explanatory matters that can be applied to the embodiments described above. The subject matters of the explanatory notes can freely be combined together unless a contradiction arises.

### Explanatory Note 1

The image sensing device 1 of FIG. 1 can be formed with hardware or a combination of hardware and software. When the image sensing device 1 is formed with software, the block diagram of a portion realized by the software represents a functional block diagram of the portion. The function realized by the software may be described as a program, and, by executing the program on a program execution device (for example, a computer), the function may be realized.

### Explanatory Note 2

For example, consideration below can be performed. The focus state adjustment portion 19 is an example of the image processing portion that can perform image processing using the distance information on the main image I_{A}, the left eye image and the right eye image; an example of the image processing is the focus state adjustment processing described above. The image processing using the distance information which the image processing portion performs on the main image I_{A}, the left eye image and the right eye image may be image processing other than the focus state adjustment processing.

What is claimed is:

1. An image sensing device comprising:
a first image sensing portion that shoots a first image;
a second image sensing portion that successively shoots a plurality of second images with focus positions different from each other;
a distance information generation portion that generates, based on the second images, distance information on subjects on the first image; and
an image processing portion that performs image processing using the distance information on the first image.

2. The image sensing device of claim 1,
wherein the subjects include a main subject and a non-main subject, and
the image processing includes processing that blurs, with the distance information, the non-main subject on the first image.

3. The image sensing device of claim 2, further comprising:
a main subject setting portion that sets the main subject either based on an image signal based on a result of the shooting by the first image sensing portion or the second image sensing portion or based on a main subject specification operation given to an operation portion.

4. The image sensing device of claim 1,
wherein a plurality of small blocks are set in an entire image region of each of the second images, and
the distance information generation portion
derives, for each of the small blocks in each of the second images, an evaluation value based on an image signal of the small block and
generates the distance information by comparing evaluation values of small blocks corresponding to each other between the second images.

5. The image sensing device of claim 1,
wherein images of the subjects shot by the second image sensing portion include a third image, and
the image processing portion also performs the image processing using the distance information on the third image.
